(19) United States
(12) Patent Application Publication
(10) Pub. No.: US 2026/0166550 A1
(43) Pub. Date: Jun. 18, 2026

(54) EWOD DEVICE WITH PATTERNED DIELECTRIC LAYER

(71) Applicant: Seagate Technology LLC, Fremont, CA (US)

(72) Inventors: Li Hong ZHANG, Singapore (SG); Barish CHAKRAVARTY, Singapore (SG); Xiong LIU, Singapore (SG); Akhil NAMBOORI, Singapore (SG)

(21) Appl. No.: 19/352,277

(22) Filed: Oct. 7, 2025

Related U.S. Application Data
(60) Provisional application No. 63/704,306, filed on Oct. 7, 2024.

(51) Int. Cl. B01L 3/00

(52) U.S. Cl. CPC B01L 3/502792; B01L 2200/12; B01L 2300/0645; B01L 2300/161; B01L 2400/0427

(57) ABSTRACT

The technology disclosed herein provides an electrowetting on dielectric device (EWOD). Implementation of the EWOD disclosed herein includes a substrate, an electrode layer configured on top of the substrate, a dielectric layer configured on the electrode layer, wherein the dielectric layer comprises a nano-patterned top surface, a top plate, a micro-fluidic channel configured between the top plate and the dielectric layer comprises a nano-patterned top surface, and a hydrophobic layer between the dielectric layer comprises a nano-patterned top surface and the micro-fluidic channel. In some implementations, a hydrophobic layer may be configured on top of the dielectric layer having a nano-patterned top surface and the micro-fluidic channel configured between the top plate and the hydrophobic layer.

### CROSS REFERENCE TO RELATED APPLICATIONS

This application is a non-provisional application based on and claims benefit of priority to U.S. provisional patent application No. 63/704,306 filed on Oct. 7, 2025, and entitled EWOD DEVICE WITH PATTERNED DIELECTRIC LAYER, which is incorporated herein by reference in its entireties.

### BACKGROUND

Digital microfluidic technology is a novel microscale liquid processing technology in which ultra-small droplets can be operated. In digital microfluidics, especially in the electrowetting on dielectric (EWOD) system, each droplet acts as an independent reactor, which enables a wide range of multiple parallel biological and chemical reactions at the microscale. The term “electrowetting” describes the effects of an electric field on the surface tension of a liquid. By decreasing the surface tension, the liquid distributes over a surface that initially repels the drop and preferably simultaneously represents an electrode. By increasing the surface tension, the liquid contracts and forms a rather spherical drop. Therefore, the liquid may be termed “electrically inducible. In the case of a single drop, the surface tension modification results in a change of the contact angle with which the drop wets the bottom surface. EWOD digital microfluidics reduces reagent and energy consumption, accelerates analysis, enables point-of-care diagnostic, simplifies integration with sensors.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Other features, details, utilities, and advantages of the claimed subject matter will be apparent from the following, more particular written Detailed Description of various implementations as further illustrated in the accompanying drawings and defined in the appended claims.

The technology disclosed herein provides an electrowetting on dielectric device (EWOD). Implementation of the EWOD disclosed herein includes a substrate, an electrode layer configured on top of the substrate, a dielectric layer configured on the electrode layer, wherein the dielectric layer comprises a nano-patterned top surface, a top plate, a micro-fluidic channel configured between the top plate and the dielectric layer comprises a nano-patterned top surface, and a hydrophobic layer between the dielectric layer comprises a nano-patterned top surface and the micro-fluidic channel. In some implementations, a hydrophobic layer may be configured on top of the dielectric layer having a nano-patterned top surface and the micro-fluidic channel configured between the top plate and the hydrophobic layer.

These and various other features and advantages will be apparent from a reading of the following Detailed Description.

### BRIEF DESCRIPTIONS OF THE DRAWINGS

A further understanding of the nature and advantages of the present technology may be realized by reference to the figures, which are described in the remaining portion of the specification. In the figures, like reference numerals are used throughout several figures to refer to similar components. In some instances, a reference numeral may have an associated sub-label consisting of a lower-case letter to denote one of multiple similar components. When reference is made to a reference numeral without specification of a sub-label, the reference is intended to refer to all such multiple similar components.

FIG. 1 illustrates an example electrowetting on dielectric (EWOD) device including a nano-patterned dielectric surface in the manner disclosed herein.

FIG. 2 illustrates and alternative example electrowetting on dielectric (EWOD) device including a nano-patterned dielectric surface in the manner disclosed herein.

FIG. 3 illustrates an example nano-patterned dielectric surface of the EWOD device disclosed herein.

### DETAILED DESCRIPTION

The technology disclosed herein relates to electrowetting on dielectric (EWOD) system. EWOD has wide applications in bioscience and DNA writing (synthesis) for DNA storage which involves travelling, merging, washing and separation of microfluids containing DNA strands or regents. An EWOD system may include actuation electrodes covered with a dielectric layer and a hydrophobic overcoat. An EWOD system may need to actuate the microdroplets at a low voltage, which can minimize the power and therefore avoid droplet heating and evaporation. Therefore, the combined dielectric & hydrophobic layers need to be thin and have high dielectric strength/constant (dielectric layer) and good hydrophobicity on the surface.

In an implementation of an EWOD system, the EWOD performance may be achieved using two layers: the dielectric layer and the hydrophobic layer. However, such two-layer system has drawbacks, including that the hydrophobicity solely depends on the chemistry of the hydrophobic layer, and therefore, such EWOD system lacks flexibility. Furthermore, some hydrophobic materials may have poor adhesion with the dielectric layer, which limits the selection of hydrophobic materials. Additionally, gaps or defects may exist between the dielectric and hydrophobic layers, thus downgrading the performance. Similarly, such multi-layers EWOD system results in complicated structure and higher cost.

For EWOD devices, having a high dielectric constant is important for the dielectric layer. Specifically, dielectric constant of the dielectric layer is proportional to the EWOD force. Here the EWOD force refers to the force exerted on a droplet on the EWOD surface due to the interaction between an electric field and the dielectric layer beneath the droplet. This force is responsible for manipulating the droplet's movement and shape on the surface, ultimately enabling precise control in various microfluidic applications.

The implementations disclosed herein provide an electrowetting on dielectric device (EWOD). Implementation of the EWOD disclosed herein includes a substrate, an electrode layer configured on top of the substrate, a dielectric layer configured on the electrode layer, wherein the dielectric layer comprises a nano-patterned top surface, a top plate, a micro-fluidic channel configured between the top plate and the dielectric layer comprises a nano-patterned top surface, and a hydrophobic layer between the dielectric layer comprises a nano-patterned top surface and the micro-fluidic channel. In some implementations, a hydrophobic layer may be configured on top of the dielectric layer having a nano-patterned top surface and the micro-fluidic channel configured between the top plate and the hydrophobic layer.

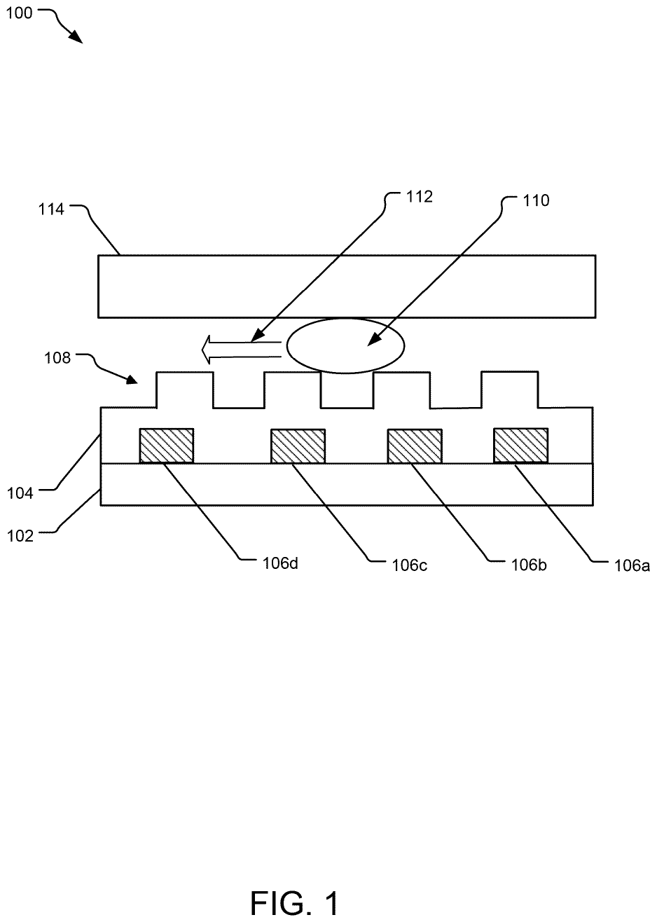

Now referring to the disclosed implementations, FIG. 1 illustrates an electrowetting on dielectric (EWOD) device 100 including a nano-patterned dielectric surface in the manner disclosed herein. Specifically, the EWOD device 100 may include a dielectric layer 104 formed on a substrate layer 102. The substrate 102 supports the functional layers of the EWOD device 100. In one implementation, the substrate 102 may be transparent and made of glass. The dielectric layer 104 may be made of a material with high dielectric strength and dielectric constant. Examples of materials that may be used for the dielectric layer 104 are as presented below in Table I.

TABLE I

| | Dielectric | Breakdown Voltage |
|---|---|---|
| Material | Constant | (×kV/mm) |
| SiO₂ | 3.9 | 10 |
| Si₂N₄ | 7.5 | 25-37 |
| SiC | 9.7 | 300 |
| HfO₂ | 25 | 20 |
| Ta₂O₅ | 26 | 40-160 |
| ZrO₂ | 29 | 19 |
| TiO₂ | 95 | 19 |
| BaTiO₃ | 1700 | 2500 |
| SeTiO₃ | 2000 | 40-170 |

In the illustrated implementation, a top surface 108 of the dielectric layer 104 is nano-patterned. Specifically, in this illustration, the nano-patterned surface 108 has a saw-tooth pattern. However, in an alternative implementation (and as further disclosed in the following figures), the nano-patterned surface 108 may have an alternative nano-pattern. Specifically, the nano-patterned surface 108 of the dielectric layer 104 may have periodic, nanostructured topographical asperities on the surface. Such nanostructures on the nano-patterned surface 108 provides desirable dewetting properties to the nano-patterned surface 108. The asperity patterns can vary from regular types such as columns, pits, islands, protrusions, nodes, or hoodoo (thin spire) features. In alternative implementations, the asperity pattern may also be random-like with controlled roughness. Both nanoscale and hybrid nano-scale patterns can be used.

A droplet 110 may be deposited on the nano-patterned surface 108. Specifically, the droplet 110 may be located between the nano-patterned surface 108 and a top glass surface 114. The droplet 110 may be moved in the direction 112 due to the electrowetting effect. Specifically, when an electric field is applied to the dielectric surface using electrodes 106, it generates electric charges (electrostatic forces) at the interface between the droplet 110 and the nano-patterned surface 108. These electrostatic forces cause a reduction of a contact angle of the droplet 110 to the surface of the dielectric layer 104. The droplet 110 may be of an aqueous or water-based liquid or of a non-aqueous liquid. For example, aqueous liquids may be distilled water, water-based biofluids, or water-based chemical solutions. On the other hand, non-aqueous liquids include DMSO, ethylene glycol, formamide, γ-butyrolactone, N-methyl formamide, etc.

The wettability of the nano-patterned surface 108 may be physically altered through the roughness of the nano-patterned surface 108. Specifically, relation between the texture or the roughness of the nano-patterned surface 108 and its hydrophobicity may be given by, for example, Wenzel's model as provided below by Equation I:

$$COS {θ}_{w} = \frac{r ( {γ}_{SV} - {γ}_{SL} )}{{γ}_{LV}} = r cos {θ}_{y} \qquad Equation I$$

$$r = \frac{{A}_{h} + {A}_{f}}{{A}_{f}} = 1 + \frac{{A}_{h}}{{A}_{f}} {r}_{S - sq} = 1 + \frac{4 ah}{{( a + b )}^{2}}$$

$$Here :$$

$${θ}_{w} is the contact angle of the modified surface$$

$${θ}_{y} the contact angle on a flat surface$$

$${A}_{f} = {( a + b )}^{2} , {A}_{h} = 4 ah + {a}^{2} + 2 ab + {b}^{2}$$

$$a is the asperity cross - sectional dimension , and$$

$$b the distance between the asperities and h the asperity height .$$

Specifically, vacuum deposited dielectric surfaces are very smooth. For example, Si₃N₄ films have the root-mean square (RMS) roughness less than 2 nm. Therefore, compared to a 1 uL droplet which has the diameter of 12.4 um, this RMS roughness is relatively small. Therefore, such vacuum deposited dielectric layer may be treated as flat. Various techniques may be used for depositing the nano-patterned surface 108. For example, the nano-patterned surface 108 may be generated using surface patterning techniques including photolithography (photolithography, e-beam lithography, electro-hydrodynamic lithography, etc.), pulsed laser texturing, and scanning probe nanolithography, etc. Such techniques can achieve the patterning scale down to nanometers, e.g., 50 nm. Such nano-patterning can satisfy hydrophobicity support for very small droplets, e.g., 1 uL.

In the EWOD device 100 disclosed in FIG. 1, only a dielectric layer 104 having the nano-patterned surface 108 exists above the surface containing the electrodes 106. Here the dielectric-layer 104 with the nano-patterned surface 108 has both the dielectric layer and hydrophobic properties to render the EWOD performance. Specifically, the movement of the droplet 110 in the direction of 112 may be achieved by activating the electrodes 106a to 106d respectively in that order. As an electrode 106 is activated, the static charges creates additional surface tension and pulls the droplet 110 towards the direction of the electrode 106 that is activated.

The movement of the droplet 110 may be caused by change in a contact angle of the droplet 110 to the nano-patterned surface 108, and in turn, the contact angle of the droplet 110 depends on the operating voltage applied to the electrodes 106, the dielectric constant of the dielectric layer 104, a dielectric constant of vacuum, the width of dielectric layer 104, the thickness of the dielectric layer 104, and surface tension between the liquid of the droplet 110 and its vapor.

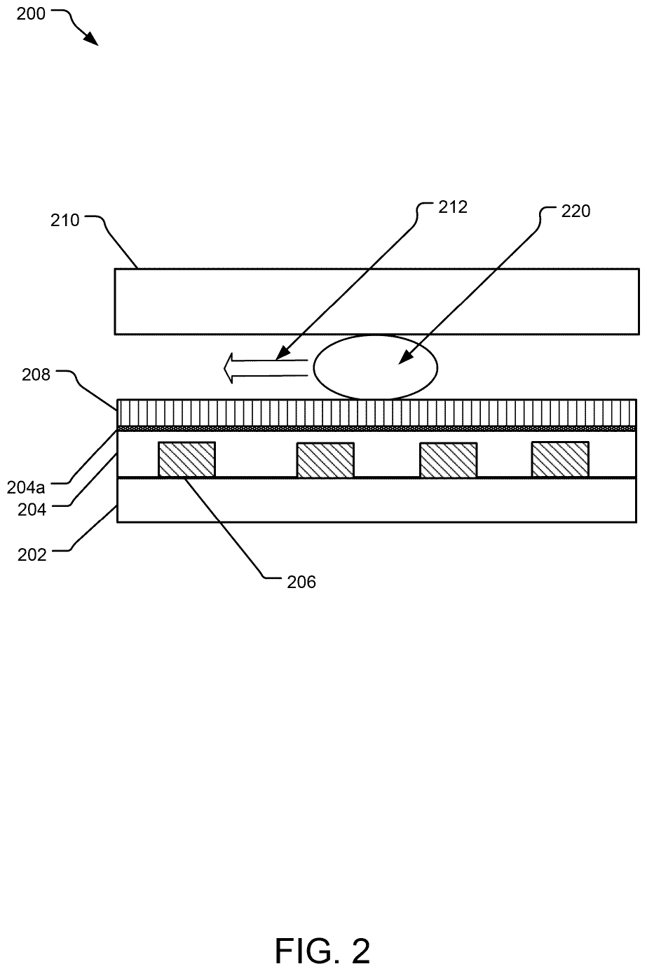

FIG. 2 illustrates and alternative implementation of an EWOD device 200 using a nano-patterned dielectric surface. Specifically, the EWOD device 200 includes a nano-patterned dielectric layer 204 deposited on a substrate 202. The nano-patterned dielectric layer 204 may include a nano-patterned surface 204a. Additionally, the EWOD device 200 also includes an organic coating 208 on top of the nano-patterned surface 204a. Specifically, the organic coating 208 may be thin layer having a thickness less than 50 nm, such as for example, 10-50 nm. The organic coating 208 strengthens the hydrophobic property of the EWOD device 200.

The nano-patterned dielectric layer 204 may be deposited on top of a number of electrodes 206 that are configured to move a droplet 220 on the organic coating 208 in a direction indicated by 212. Specifically, the droplet 220 may move between the organic coating 208 and a top glass surface 114.

The EWOD device 200 including the nanopatterned surface 204a and the organic coating provides a number of technical advantages to the EWOD device 200 including higher selection flexibility for the organic layer 208. Specifically, the organic layer 208 may be made of fluoric chemicals or others like siloxane. While siloxane without the nanopatterned surface 204a can not achieve desirable contact angles, it can render very good hydrophobicity with the nano-patterned substrate 204a. Additionally, because contact angle for the two-layer EWOD device 200 with the nano-patterned dielectric layer 204 depends on the hydrophobic chemistry of the organic layer 208 and the patterns of the nano-patterned dielectric layer 204, the organic layer 208 may be thinner than existing EWOD device. For example, for the EWOD device 200, the thickness of the organic layer 208 may be less than 50 nm, such as for example, 10-50.

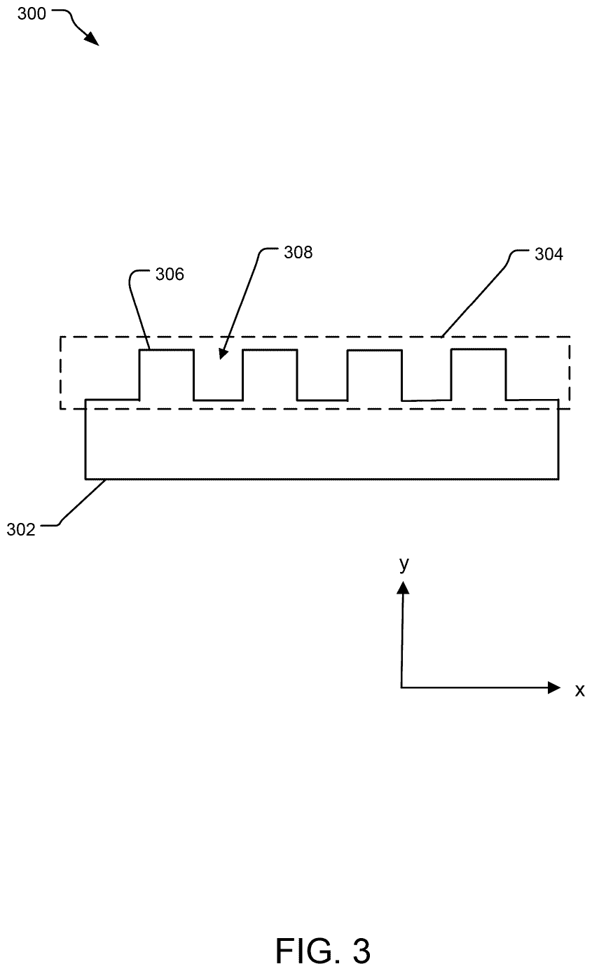

FIG. 3 illustrates an example nano-patterned dielectric surface 300 of the EWOD device disclosed herein. Specifically, a dielectric layer 302 may have a nano-patterned surface 304 that has a tooth pattern with a number of peaks 306 and troughs 308. The longitudinal thickness, in the direction of x-axis, of the peaks 306 and troughs 308 may be used to control the roughness and therefore the droplet wettability on the nano-patterned dielectric layer surface 304. The patterns of the nano-patterned surface 304 may be prepared using surface patterning techniques including photolithography (photolithography, e-beam lithography, electro-hydrodynamic lithography, etc.), pulsed laser texturing, and scanning probe nanolithography, etc.

In alternative implementations, the asperity pattern of the nano-patterned surface 304 may have alternative shapes such as columns, pits, islands, protrusions, nodes, or hoodoo (thin spire) features to provide roughness to the dielectric layer 302.

The EWOD devices having nano-patterned dielectric surface, as disclosed herein, provide a number of technical advantages over the existing solutions. Specifically, such EWOD devices are able to reduce the actuation voltage, which may reduce the energy consumption and minimize droplet heating and evaporation. Additionally, EWOD devices having nano-patterned dielectric surface can facilitate the wettability control of the microdroplets. This is because the desired water contact angle can be achieved through both the chemistry and physical patterning. Furthermore, EWOD devices having nano-patterned dielectric surface can also facilitate and broaden the selections of the dielectric materials and the hydrophobic materials. Finally, the EWOD devices having nano-patterned dielectric surface simplify the EWOD system design when the one-layer system is used for both the dielectric and hydrophobic performances.

The above specification, examples, and data provide a complete description of the structure and use of example embodiments of the disclosed technology. Since many embodiments of the disclosed technology can be made without departing from the spirit and scope of the disclosed technology, the disclosed technology resides in the claims hereinafter appended. Furthermore, structural features of the different embodiments may be combined in yet another embodiment without departing from the recited claims.

What is claimed is:

1. A device, comprising:
a substrate;
an electrode layer configured on top of the substrate;
a dielectric layer configured on the electrode layer, wherein the dielectric layer comprises a nano-patterned top surface;
a top plate; and
a micro-fluidic channel configured between the top plate and the dielectric layer comprises a nano-patterned top surface.

2. The device of claim 1, wherein the nano-patterned surface of the dielectric layer includes a rectangle-shaped tooth pattern.

3. The device of claim 1, wherein the nano-patterned surface of the dielectric layer includes a triangle-shaped tooth pattern.

4. The device of claim 1, further comprising a hydrophobic layer between the dielectric layer comprises a nano-patterned top surface and the micro-fluidic channel.

5. The device of claim 1, wherein the nano-patterned surface of the dielectric layer if formed using at least one of photolithography, e-beam lithography, and electro-hydrodynamic lithography.

6. The device of claim 1, wherein the nano-patterned surface of the dielectric layer if formed using at least one of pulsed laser texturing and scanning probe nanolithography.

7. The device of claim 1, wherein the width of the nano-patterns on the nano-patterned surface is less than 100 nm.

8. The device of claim 1, wherein the nano-patterned surface provides hydrophobicity support for droplets having width of less than 2 uL.

9. The device of claim 6, wherein the is made of at least one of Ta2O5, SiO2, Si3N4, and BaTiO3.

10. An electrowetting on dielectric device (EWOD), comprising:
a substrate;
an electrode layer configured on top of the substrate;
a dielectric layer configured on the electrode layer, wherein the dielectric layer comprises a nano-patterned top surface;
a top plate;
a micro-fluidic channel configured between the top plate and the dielectric layer comprises a nano-patterned top surface; and
a hydrophobic layer between the dielectric layer comprises a nano-patterned top surface and the micro-fluidic channel.

11. The EWOD of claim 10, wherein the nano-patterned surface of the dielectric layer includes a rectangle-shaped tooth pattern.

12. The EWOD of claim 10, wherein the nano-patterned surface of the dielectric layer includes a triangle-shaped tooth pattern.

13. The EWOD of claim 10, wherein the nano-patterned surface of the dielectric layer if formed using at least one of photolithography, e-beam lithography, and electro-hydrodynamic lithography.

14. The EWOD of claim 10, wherein the nano-patterned surface of the dielectric layer if formed using at least one of pulsed laser texturing and scanning probe nanolithography.

15. The EWOD of claim 10, wherein the width of the nano-patterns on the nano-patterned surface is less than 100 nm.

16. The EWOD of claim 10, wherein the nano-patterned surface provides hydrophobicity support for droplets having width of less than 2 uL.

17. An electrowetting on dielectric (EWOD) system, comprising:
a substrate;
an electrode layer configured on top of the substrate;
a dielectric layer configured on the electrode layer, wherein the dielectric layer comprises a nano-patterned top surface;
a top plate;
a micro-fluidic channel configured between the top plate and the dielectric layer comprises a nano-patterned top surface; and
a hydrophobic layer between the dielectric layer comprising a nano-patterned top surface and the micro-fluidic channel.

18. The system of claim 17, wherein the nano-patterned surface of the dielectric layer includes at least one of a rectangle-shaped tooth pattern and a triangle-shaped tooth pattern.

19. The system of claim 17, wherein the nano-patterned surface of the dielectric layer if formed using at least one of photolithography, e-beam lithography, and electro-hydrodynamic lithography.

20. The system of claim 17, wherein the nano-patterned surface of the dielectric layer if formed using at least one of pulsed laser texturing and scanning probe nanolithography.
